(19) United States
(12) Patent Application Publication
(10) Pub. No.: US 2023/0253691 A1
(43) Pub. Date: Aug. 10, 2023

(54) CYLINDRICAL SECONDARY BATTERY

(71) Applicant: Samsung SDI Co., Ltd., Yongin-si (KR)

(72) Inventor: Hyun Ki JUNG, Yongin-si (JP)

(21) Appl. No.: 18/163,139

(22) Filed: Feb. 1, 2023

(30) Foreign Application Priority Data
Feb. 7, 2022 (KR) 10-2022-0015468

(51) Int. Cl. H01M 50/636; H01M 50/107; H01M 50/166; H01M 50/183; H01M 10/0585

(52) U.S. Cl. CPC H01M 50/636; H01M 50/107; H01M 50/166; H01M 50/183; H01M 10/0585

(57) ABSTRACT

A secondary battery includes: an electrode assembly including a positive electrode plate and a negative electrode plate; a case accommodating the electrode assembly, one side of the case being open; a first current collector plate and a second current collector plate, each of the first and second current collect plates being electrically connected to the electrode assembly and the case; and a cap assembly including a cap plate sealing the case. The cap plate has an injection port extending therethrough and an injection plug sealing the injection port.

### CROSS-REFERENCE TO RELATED APPLICATION

This application claims priority to and the benefit of Korean Patent Application No. 10-2022-0015468, filed on Feb. 7, 2022, in the Korean Intellectual Property Office, the entire content of which is incorporated herein by reference.

### BACKGROUND

### 1. Field

Aspects of embodiments of the present disclosure relate to a cylindrical secondary battery.

### 2. Description of the Related Art

Generally, a cylindrical secondary battery includes a cylindrical electrode assembly, a cylindrical case accommodating the electrode assembly and an electrolyte, and a cap assembly coupled at an upper opening of the case to seal the case and to allow the current generated from (or stored in) the electrode assembly to flow to an external device.

The cylindrical secondary battery has a structure in which a case having (or acting as) a negative electrode and a cap assembly having (or acting as) a positive electrode are insulated from each other by a gasket with the negative electrode generally being below the battery. However, in other cases, both the negative electrode and the positive electrode may be provided on one side.

The above information disclosed in this Background section is for enhancement of understanding of the background of the present disclosure, and therefore, it may contain information that does not constitute prior art.

### SUMMARY

An embodiment of the present disclosure provides a cylindrical secondary battery in which a positive electrode and a negative electrode are at a same side (or end) thereof.

A secondary battery, according to an embodiment of the present disclosure, includes: an electrode assembly including a positive electrode plate and a negative electrode plate; a case accommodating the electrode assembly, one side of the case being open; a first current collector plate and a second current collector plate, each of the first and second current collect plates being electrically connected to the electrode assembly and the case; and a cap assembly including a cap plate sealing the case. The cap plate has an injection port extending therethrough and an injection plug sealing the injection port.

The injection plug may have a cylindrical body with an empty interior, a pressing part at one end of the body, and a cylindrical separating part at another end of the body and connected to the pressing part through the interior of the body.

In the injection plug, the body and the pressing part may be inside the injection port in the cap plate and the separating part may be outside the cap plate.

An outer diameter of the pressing part may be larger than an inner diameter of the body.

The separating part may be connected to the pressing part such that, when the separating part is pulled away from the cap plate, the pressing part moves into the body and increases the outer diameter of the body.

The body may include a material having an elongation suitable to receive the pressing part.

The body may have a circular portion that extends perpendicular to a longitudinal direction of the body and may be at an end of the body facing outside the cap plate. The circular portion may have a diameter greater than that of the body.

The injection plug may be a blind rivet.

The cap plate may be insulated from the case.

The secondary battery may further include a terminal coupled to a surface of the case opposite to the cap plate and insulated from the case, and the terminal may be electrically connected to the first current collector plate or to the second current collector plate.

The secondary battery may further include a positive electrode terminal coupled to a surface of the case opposite to the cap plate and insulated from the case. The positive electrode terminal may be electrically connected to the positive electrode plate, and the cap plate may be at one end of the case and electrically connected to the negative electrode plate.

According to embodiments of the present disclosure, an electrolyte injection structure may be improved, and thus, process efficiency may be improved. In addition, because both the positive electrode and the negative electrode are formed in one direction (or are at one end) of the secondary battery, a connection structure with an external terminal may be simplified.

### BRIEF DESCRIPTION OF DRAWINGS

FIG. 1 is a perspective view of a cylindrical secondary battery according to an embodiment of the present disclosure.

FIG. 2 is a cross-sectional view of the cylindrical secondary battery shown in FIG. 1.

FIG. 3A is a schematic diagram schematically showing an initial step of a cap assembly assembling process.

FIG. 3B is a schematic diagram schematically showing a subsequent stage of the cap assembly assembling process shown in FIG. 3A.

FIG. 4 is a perspective view schematically showing an injection plug and a mounting tool according to an embodiment of the present disclosure.

FIGS. 5A to 5C are schematic diagrams schematically showing an injection plug mounting process according to an embodiment of the present disclosure.

### DETAILED DESCRIPTION

Embodiments of the present disclosure are provided to more completely explain aspects and features of the present disclosure to those skilled in the art. The following embodiments may be modified to have various other forms. Thus, The present disclosure should not be construed as being limited to the embodiments set forth herein. Rather, these embodiments are provided so that this disclosure will be thorough and complete and will convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, a cylindrical secondary battery according to an embodiment of the present disclosure will be described, in detail, with reference to the accompanying drawings.

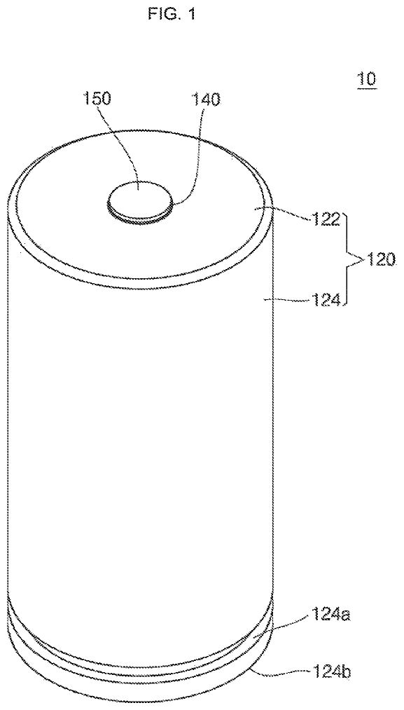

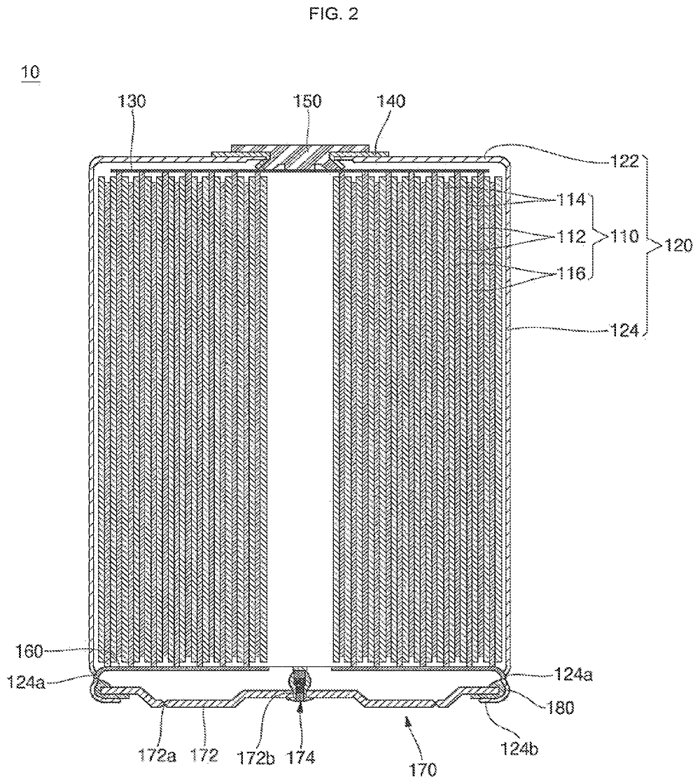

FIG. 1 is a perspective view showing a cylindrical secondary battery according to an embodiment of the present disclosure. FIG. 2 is a cross-sectional view of the cylindrical secondary battery shown in FIG. 1.

As shown in FIGS. 1 and 2, the secondary battery 10 according to an embodiment of the present disclosure may include an electrode assembly 110, a case 120, a first current collector plate 130, a first gasket 140, a positive electrode terminal 150, a second current collector plate 160, and a cap assembly 170.

As shown in FIG. 2, the electrode assembly 110 may include a first electrode

The first electrode plate 112 may be a negative electrode plate or a positive electrode plate. For example, the first electrode plate may be a positive electrode plate. When the first electrode plate 112 is a positive electrode plate, it may be formed of a metal thin plate having excellent conductivity, for example, aluminum foil or mesh and may include a positive electrode coated portion that is coated with a positive electrode active material and a positive electrode uncoated portion that is not coated with a positive electrode active material. For example, the positive electrode active material may be formed of a chalcogenide compound, for example, a composite metal oxide, such as LiCo₂, LiMn₂O₄, LiNiO₂, LiNiMnO₂, or the like.

The second electrode plate 114 may be the other of the negative electrode plate and the positive electrode plate. For example, when the first electrode plate 112 is a positive electrode plate, the second electrode plate 114 may be a negative electrode plate. When the second electrode plate 114 is a negative electrode plate, it may be made of a thin conductive metal plate, for example, copper or nickel foil or mesh and may include a negative electrode coated portion that is coated with an anode active material and a negative electrode uncoated portion that is not coated with an anode active material. For example, the negative electrode active material may be formed of a carbon-based material, Si, Sn, tin oxide, a tin alloy composite, a transition metal oxide, lithium metal nitrite, or a metal oxide.

The separator 116 is interposed between the first electrode plate 112 and the second electrode plate 114 to prevent a short circuit therebetween. For example, the separator 116 may be made of polyethylene, polypropylene, a porous copolymer of polyethylene and polypropylene, or the like.

For example, in the electrode assembly 110, the uncoated portion of the first electrode plate 112 is disposed to protrude upwardly from (or above) the top end of the second electrode plate 114, and the uncoated portion of the second electrode plate 114 may be disposed to protrude downwardly from (or below) the lower end of the first electrode plate 112 and may be wound in a jelly-roll shape.

As shown in FIG. 2, the case 120 may have a cylindrical shape with one surface open to accommodate the electrode assembly 110 with the other surface being closed. While FIG. 2 illustrates an embodiment in which the lower surface is open and the upper surface is closed, in other embodiments, the upper surface may be opened and the lower surface may be closed. In addition, the case 120 shown in FIG. 2 having the lower surface being open may be turned over such that the upper surface is then open. Therefore, in the present disclosure, the upper surface, the lower surface, and the up-down direction are terms defined on the basis of the orientation of FIGS. 1 and 2 are are not terms defined according to absolute directions.

The case 120 may have a circular upper surface portion 122 and a side portion 124 extending downwardly from the upper surface portion 122. A curling part 124a and a crimping part 124b may be formed below the side portion 124.

The curling part 124a is an inwardly concavely processed part in an approximately semicircular shape from the outside of the side portion 124. The curling part 124a is different from a beading part formed in a conventional cylindrical secondary battery in that the curling part 124a is deformed to a smaller degree than the beading part is. The curling part 124a fixes the second current collector plate 160, which will be described later, to support the cap assembly 170 when assembling the cap assembly 170. The crimping part 124b is formed by bending the lower end of the side portion 124 in the inner direction of (e.g., toward an inside of) the case 120. The crimping part 124b fixes the cap assembly 170 so that it is not separated to the outside of the case 120. The first current collector plate 130 is provided between the upper surface portion 122 and the electrode assembly 110, and the second current collector plate 160 is provided between the cap assembly 170 and the electrode assembly 110.

As shown in FIG. 2, the first current collector plate 130 is disposed between the upper surface portion 122 and the uncoated portion of the first electrode plate 112. The first current collector plate 130 may be in contact with the first electrode plate 112 to act as a positive electrode plate to be electrically connected thereto. In addition, the first current collector plate 130 is electrically connected to the positive electrode terminal 150 installed on the upper surface portion 122. The first gasket 140 may be provided between the first current collector plate 130 and the positive electrode terminal 150. The second current collector plate 160 is disposed between the cap assembly 170 and the uncoated portion of the second electrode plate 114. The second current collector plate 160 may be in contact with the second electrode plate 114 to act as a negative electrode plate to be electrically connected thereto. In addition, an edge of the second current collector plate 160 may be in contact with the side portion 124 of the case 120 to be electrically connected thereto. The cap assembly 170 may be disposed under the second current collector plate 160.

As shown in FIG. 2, the first gasket 140 is inserted between the positive electrode terminal 150 and the upper surface portion 122 to insulate the upper surface portion 122 and the positive electrode terminal 150 from each other.

As shown in FIGS. 1 and 2, the positive electrode terminal 150 is partially exposed to the outside of the upper surface portion 122 and is electrically connected to the first current collector plate 130. For example, the positive electrode terminal 150 may be a rivet-type terminal.

As shown in FIG. 2, the cap assembly 170 is coupled at the open lower portion of the case 120 to close the case 120. The cap assembly 170 may include a cap plate 172 and an injection plug 174 coupled to the cap plate 172.

The cap plate 172 is a substantially disk-shaped plate and may be coupled to the side portion 124 by a second gasket 180. The cap plate 172 may be fixed to the case 120 by the curling part 124a and the crimping part 124b, which will be described later. Because the second gasket 180 is disposed between the cap plate 172 and the side portion 124, the cap plate 172 is insulated from the case 120. In addition, because the case 120 acts as a negative electrode and the positive electrode terminal 150 is disposed on the case 120, both the positive electrode and the negative electrode of the secondary battery 10 may be disposed on the secondary battery 10 (e.g., on a same side of the secondary battery 10). In addition, a notch 172a acting as a safety vent for discharging gas under certain conditions may be formed on (or in) the plate surface of the cap plate 172. For example, the edge and central regions of the cap plate 172 may be formed to be closer to the second current collector plate 160 than the region at where the notch 172a is formed (e.g., the edge and central regions of the cap plate 172 may be formed to be depressed inwardly). An injection port (e.g., an injection opening or hole) 172b for injecting an electrolyte into the case 120 may be formed through the central region of the cap plate 172. The injection port 172b may have a substantially circular shape. After the electrolyte is injected, the injection plug 174 may be inserted into the injection port 172b.

For example, the injection plug 174 may be provided as a blind rivet. Hereinafter, the shape and installation process of the injection plug 174 will be described in more detail.

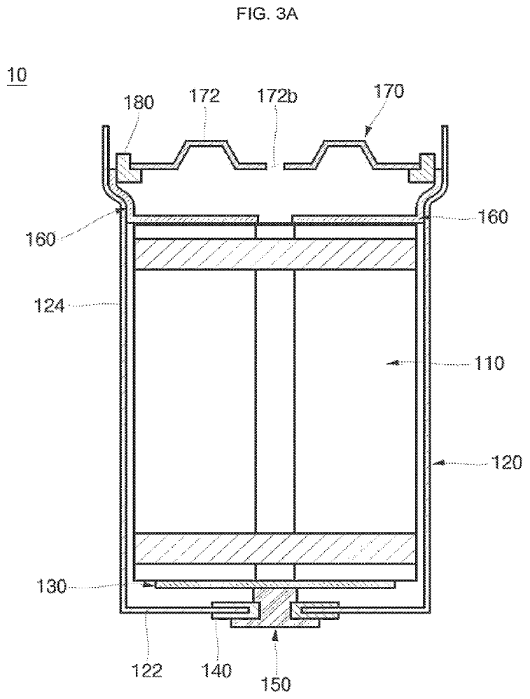

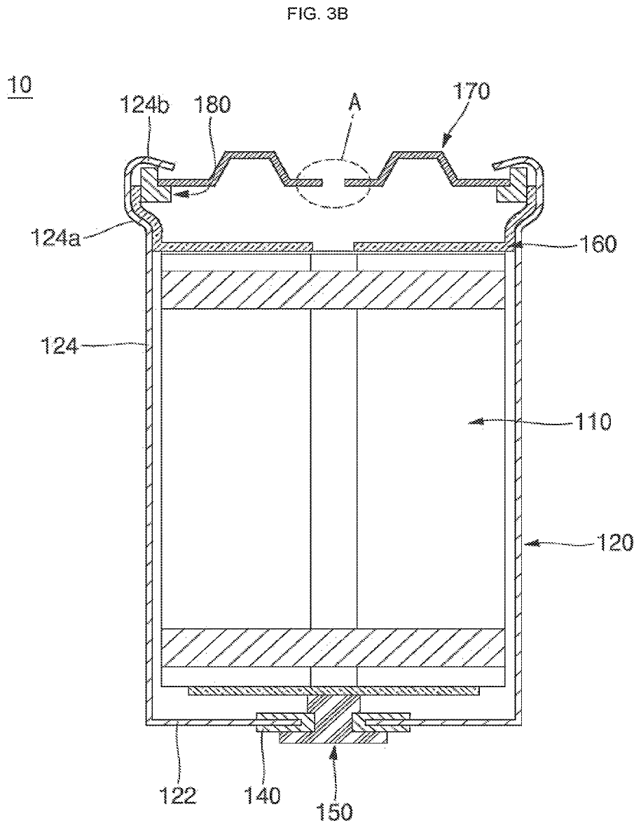

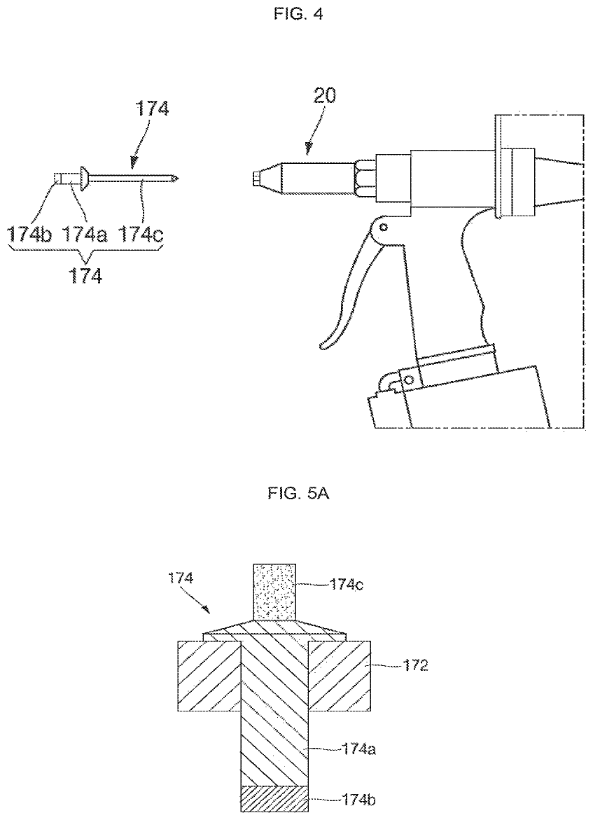

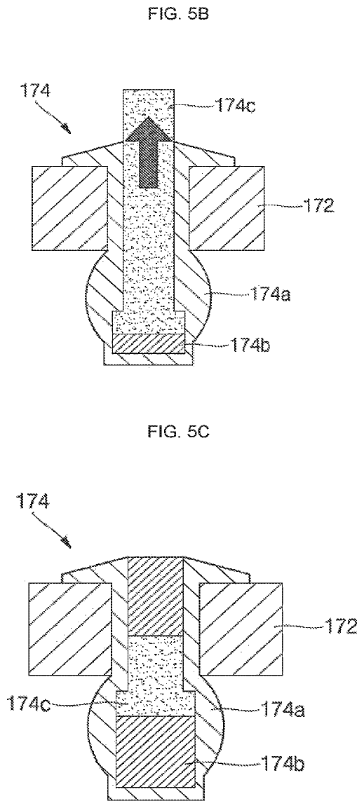

FIG. 3A is a schematic diagram schematically showing an initial stage of a cap assembly assembling process of the secondary battery 10 shown in FIGS. 1 and 2, and FIG. 3B is a schematic diagram schematically showing a later stage of the cap assembly assembling process shown in FIG. 3A. FIG. 4 is a perspective view schematically showing an injection plug and a mounting tool according to an embodiment of the present disclosure. FIGS. 5A to 5C are schematic diagrams schematically showing an injection plug mounting process according to an embodiment of the present disclosure.

As shown in FIG. 3A, the first gasket 140 and the positive electrode terminal 150 may be installed on the upper surface portion 122 of the case 120 during the assembling process of the secondary battery 10. Then, the first current collector plate 130 and the electrode assembly 110 may be electrically connected and inserted into the case 120. Thereafter, the case 120 may be turned over and disposed so that the upper surface portion 122 faces downwardly, and the second current collector plate 160 may then be electrically connected to the electrode assembly 110. Thereafter, the curling part 124a may be formed, and the second gasket 180 and the cap plate 172 may then be disposed. Accordingly, the injection port 172b formed in the cap plate 172 is positioned above the case 120.

As shown in FIG. 3B, after seating the cap plate 172 on the case 120, the end of the side portion 124 may be bent to form the crimping part 124b, thereby fixing the cap plate 172 to the case 120. Thereafter, the electrolyte may be injected through the injection port 172b, and then, the injection plug 174 may be installed to close the injection port 172b.

As shown in FIGS. 4 to 5C, the injection plug 174 may be fixed to the cap plate 172 by using a separate mounting mechanism 20. The injection plug 174 may include a body 174a, a pressing part 174b, and a separating part 174c to be fixed to the mounting mechanism 20. As described above, the injection plug 174 may be a blind rivet.

The body 174a has a substantially cylindrical shape with an empty (or hollow) interior. The pressing part 174b is disposed at one end of the body 174a toward the inside of the case 120. The other end of the body 174a facing the outside of the case 120 extends in a substantially circular plate shape. The circular portion of the body 174a has a larger diameter than the other portions of the body 174a and extends perpendicular to the longitudinal direction (e.g., the extension direction) of the other portions of the body 174a. Therefore, as shown in FIG. 5A, the cross-section of the body 174a has an approximately capital letter “T” shape. The approximately circular portion of the body 174a is exposed in the same shape as the head of a bolt when viewed from the outside of the case 120. The separating part 174c is formed at the other end of the body 174a, and the pressing part 174b and the separating part 174c are connected inside the body 174a. When the pressing part 174b is pulled as the separating part 174c is pulled by the mounting mechanism 20, the cylindrically-shape empty interior of the body 174a accommodates the pressing part 174b as it is pulled therein. In addition, the body 174a may be made of an elastic material (e.g., a material having a certain or predetermined elasticity) to accommodate the pressing part 174b. As used herein, “elasticity” does not mean elasticity, such as how rubber or silicone as elastic, but should be understood to mean that the material has an elongation rate suitable to deform such that the pressing part 174b can be press-fitted into the body 174a. For example, the body 174a may be made of aluminum or a metal material having a similar elongation.

The pressing part 174b is provided at one end of the body 174a and may be formed in a cylindrical shape or a hemispherical shape. The pressing part 174b may have a shorter length than that of the body 174a and may have the same outer diameter as the body 174a. Although the outer diameter of the pressing part 174b may be slightly smaller than the outer diameter of the body 174a, at least the outer diameter of the pressing part 174b may be larger than the inner diameter of the body 174a. The pressing part 174b is connected to the separating part 174c in (or through) the interior of the body 174a.

The separating part 174c has a substantially cylindrical shape. One end of the separating part 174c is inserted into the body 174a and integrally formed with the pressing part 174b, and the other end thereof is exposed toward the other end of the body 174a. Therefore, the diameter of the separating part 174c is smaller than the diameter of the body 174a, and the length of the separating part 174c is longer than the length of the body 174a. The separating part 174c is inserted into and fixed in the mounting mechanism 20 and pulls the pressing part 174b toward the mounting mechanism 20. The separating part 174c may be separated and removed from the pressing part 174b after the injection plug 174 is mounted to the cap plate 172.

The injection plug 174 having the above-described structure is inserted into the injection port 172b formed in the cap plate 172 such that the body 174a and the pressing part 174b are under (or inside) the cap plate 172, as shown in, for example, FIG. 5A. The pressing part 174b is disposed toward (e.g., faces) the inside of the case 120. Because the injection port 172b is to be sealed by the injection plug 174, the diameter of the cylindrical portion of the body 174a may be formed to correspond to the inner diameter of the injection port 172b.

After the separating part 174c is mounted and fixed to the mounting mechanism 20, when the separating part 174c is pulled outward of the case 120 (in the arrow direction shown in FIG. 5B), the pressing part 174b connected to the separating part 174c is pulled together therewith. Because the outer diameter of the pressing part 174b is larger than the inner diameter of the body 174a, the body 174a is deformed as the pressing part 174b is pulled inward of (e.g., into) the body 174a, and the diameter of the body 174a may increase as shown in, for example, FIG. 5B.

Because the inner diameter of the pressing part 174b is larger than the inner diameter of the body 174a, even when being pulled, the pressing part 174b may be contact (e.g., may be caught on or restrained by) the cap plate 172, as shown in, for example, FIG. 5C, rather than being pulled to the outside of the injection port 172b. In this state, the separating part 174c is cut (e.g., is cut or separated from the body 174a) by the mounting mechanism 20, and the pressing part 174b is fixed while inserted into the body 174a. Accordingly, the injection port 172b may be maintained in a sealed state by the injection plug 174.

As described above, according to embodiments of the present disclosure, because both the positive electrode and the negative electrode are formed in one direction of the secondary battery, a connection structure with an external terminal may be simplified.

In addition, an electrolyte injection structure may be improved and, thus, process efficiency may be improved.

While the foregoing embodiments are only some of the embodiments for carrying out the present disclosure, which is not limited to these embodiments, it will be understood by a person skilled in the art that various changes in form and details may be made thereto without departing from the spirit and scope of the present disclosure as defined by the following claims and their equivalents.

What is claimed is:

1. A secondary battery comprising:
an electrode assembly comprising a positive electrode plate and a negative electrode plate;
a case accommodating the electrode assembly, one side of the case being open;
a first current collector plate and a second current collector plate, each of the first and second current collect plates being electrically connected to the electrode assembly and the case; and
a cap assembly comprising a cap plate sealing the case, the cap plate having an injection port extending therethrough and an injection plug sealing the injection port.

2. The secondary battery of claim 1, wherein the injection plug has a cylindrical body with an empty interior, a pressing part at one end of the body, and a cylindrical separating part at another end of the body and connected to the pressing part through the interior of the body.

3. The secondary battery of claim 2, wherein, in the injection plug, the body and the pressing part are inside the injection port in the cap plate and the separating part is outside the cap plate.

4. The secondary battery of claim 3, wherein an outer diameter of the pressing part is larger than an inner diameter of the body.

5. The secondary battery of claim 4, wherein the separating part connected to the pressing part such that, when the separating part is pulled away from the cap plate, the pressing part moves into the body and increases the outer diameter of the body.

6. The secondary battery of claim 5, wherein the body comprises a material having an elongation suitable to receive the pressing part.

7. The secondary battery of claim 6, wherein the body has a circular portion that extends perpendicular to a longitudinal direction of the body and is at an end of the body facing outside the cap plate, and
wherein the circular portion has a diameter greater than that of the body. rivet.

8. The secondary battery of claim 1, wherein the injection plug is a blind

9. The secondary battery of claim 1, wherein the cap plate is insulated from the case.

10. The secondary battery of claim 9, further comprising a terminal coupled to a surface of the case opposite to the cap plate and insulated from the case,
wherein the terminal is electrically connected to the first current collector plate or to the second current collector plate.

11. The secondary battery of claim 1, further comprising a positive electrode terminal coupled to a surface of the case opposite to the cap plate and insulated from the case,
wherein the positive electrode terminal is electrically connected to the positive electrode plate, and
wherein the cap plate is at one end of the case and electrically connected to the negative electrode plate.
